(19) United States
(12) Patent Application Publication
(10) Pub. No.: US 2008/0181507 A1
(43) Pub. Date: Jul. 31, 2008

(54) Image manipulation for videos and still images

(75) Inventors: Chandan Gope, Cupertino, CA (US); Amit Agarwal, San Jose, CA (US); Vaidhi Nathan, San Jose, CA (US); Alexander Bovyrin, Nizhny Novgorod (RU); Ilya Popov, Nizhny Novgorod (RU); Lev Afraimovich, Nizhny Novgorod (RU)

Correspondence Address: DAVID LEWIS, 1250 AVIATION AVE., SUITE 200B, SAN JOSE, CA, 95110, US

(73) Assignee: Intellivision Technologies Corp.

(21) Appl. No.: 12/011,705

(22) Filed: Jan. 28, 2008

Related U.S. Application Data
(60) Provisional application No. 60/898,341, filed on Jan. 29, 2007.
(60) Provisional application No. 60/898,472, filed on Jan. 30, 2007.
(60) Provisional application No. 60/898,603, filed on Jan. 30, 2007.

(51) Int. Cl. G06K 9/46; G06K 9/03; G06K 9/40; G06K 9/36

(52) U.S. Cl. 382/190; 382/309; 382/264; 382/255; 382/284

(57) ABSTRACT

In an embodiment, an image is received having a first portion and one or more other portions. The one or more other portions are replaced with one or more other images. The replacing of the one or more portions results in an image including the first portion and the one or more other images. In an embodiment, the background of an image is replaced with another background. In an embodiment, the foreground is extracted by identifying the background based on an image of the background without any foreground. In an embodiment, the foreground is extracted by identifying portions of the image that have characteristics that are expected to be associated with the background and characteristics that are expected to be associated with foreground. In an embodiment any of the images can be still images. In an embodiment, any of the images are video images.

### CROSS-REFERENCE TO RELATED APPLICATIONS

This application claims priority benefit of U.S. Provisional Patent Application No. 60/898,341 (Docket #53-1), filed Jan. 29, 2007, which is incorporated herein by reference; this application also claims priority benefit of U.S. Provisional Patent Application No. 60/898,472 (Docket #53-2), filed Jan. 30, 2007, which is also incorporated herein by reference; and this application claims priority benefit of U.S. Provisional Patent Application No. 60/898,603 (Docket #53-3), filed Jan. 30, 2007, which is also incorporated herein by reference.

### FIELD

The method relates in general to video and image processing.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

In the prior art, a picture or video is taken of one or more people on a blank background. Then the images of people are placed into another image. However, it is not always convenient or possible to photograph people on a blank background. Also, the combined image often has transitions that do not look natural.

### SUMMARY

In an embodiment, a method and/or system for removing a background from a video or still picture and replacing the background with another background is provided. In an embodiment, a method for extracting a single person or multiple people requiring only a single video input is provided. In an embodiment, a method for extracting a single person or multiple people requiring only a single video or image input is provided.

The extraction can be performed from both simple as well as complex background conditions. In an embodiment, the extraction may include identifying and then extracting multiple people (if multiple people are present in the scene), without requiring an empty scene as a starting point. The data extracted may include multiple elements in a video scene, which may include a foreground and background. Instead of extracting the person and/or simply replacing the background, all elements (people, scenes or objects) may be intelligently extracted, blended, and/or joined in different ways and forms. The information fusion and/or object transformation may include steps such as translation, rotation, scaling, illumination, panning, zooming in and out, fading, blending, blurring, morphing, adding extra objects on or beside people, caricaturing, changing the appearance, and/or any combination thereof.

In this specification the word “image” is generic to video and still images. In this specification, a video image is a series of frames, which when viewed in rapid succession produce a moving or still picture. In this specification, a person and various other types of objects are used as examples of a foreground. However, the person and other examples of the foreground may be replaced with any foreground of interest, which may include any number of foreground elements. The system may build a background model by analyzing multiple images or frames. The system may take a portion of the same video input or camera input, either from the initial or later video segments, to identify the background and separate the foreground elements of interest from any background, without having a need for a customized background image or second video. However, the person and other examples of foreground may be replaced with any foreground of interest, which may include any number of foreground elements. In an embodiment, the extraction may include identifying and then extracting multiple people (if multiple people are present in the scene), without requiring an empty scene as a starting point. The method analyzes multiple features of the data, such as the luminance, the chrominance, the gradient in pixel intensities, the edges of objects, the texture, and the motion. The features analyzed may facilitate separating the foreground (e.g., a person) pixels from the background pixels. The method automatically adapts to changing background conditions such as lighting changes and introduction/removal of inanimate objects. Additionally, the method extracts temporal information from past frames to facilitate making the final decision intelligently for the current frame. The method may continually learn to identify the background and may be capable of adapting to lighting changes, to better distinguish and extract the person. In an embodiment, the system offers the user an option for replacing the background with another video background, a fixed image, or a sequence of static images, for example. The system may also offer the user an option for enhancing the final image by blending and/or smoothing the boundary that defines a profile of a foreground element of interest to give a better visual and realistic effect. In an embodiment, the system includes an image processing algorithm that has various modules that are automatically triggered based on different features and/or the complexity of the scene.

The method may include separating out specific objects and then intelligently transforming and blending the objects to create a compelling new visual palette.

In an embodiment, the method is implemented by a system for combining two or more images and/or videos from different sensors into a single video or multiple images or videos.

The method analyzes multiple features of the data, such as the luminance, the chrominance, the gradient in pixel intensities, the edges of objects, the texture, and the motion. The features analyzed may facilitate separating the foreground pixels (e.g., a person) from the background pixels. The method automatically adapts to changing background conditions such as lighting changes and introduces/removes of inanimate objects. Additionally, the method extracts temporal information from past frames to facilitate making the final decision intelligently for the current frame.

In an embodiment, fixed or moving, still or video cameras may be used for the input videos. The input may be the original source video, which may facilitate identifying and extracting one or more foreground elements, such as a person, without the need of a second video or background image. The inputs to the method include multiple people, scenes, and objects from difference image (e.g., which may be indicative of motion) and/or video sources, and the output of the system is a fusion of the inputs that is transformed, in the form of single or multiple still images or videos. In an embodiment, the system can extract multiple people from a scene. The input to the system may be video data (live or offline) and the system may extract one or more people from the video using a combination of sophisticated image processing and computer vision techniques. In an embodiment, fixed or moving, still or video cameras may be used for the input videos.

### BRIEF DESCRIPTION OF THE FIGURES

In the following drawings, like reference numbers are used to refer to like elements. Although the following figures depict various examples of the invention, the invention is not limited to the examples depicted in the figures.

FIG. 1A shows an embodiment of a system for manipulating images.

FIG. 1B shows a block diagram of the system of FIG. 1A.

FIG. 1C is a block diagram of an embodiment of the memory system of FIG. 1B.

FIG. 2 is a flowchart of an embodiment of a method for manipulating images.

FIG. 3 shows a flowchart of another embodiment of a method for manipulating images.

FIG. 4 shows a flowchart of another embodiment of a method for manipulating images.

FIG. 5 shows a flowchart of an embodiment of a method for extracting a foreground.

FIG. 6 shows a flowchart of an example of a method for improving the profile of the foreground.

FIG. 7 shows a flowchart of an embodiment of a method for fusing and blending elements.

FIG. 8 shows an example of switching the background image.

FIG. 9 is a flowchart of an example of a method for making the system of FIGS. 1A and 1B.

### DETAILED DESCRIPTION

Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

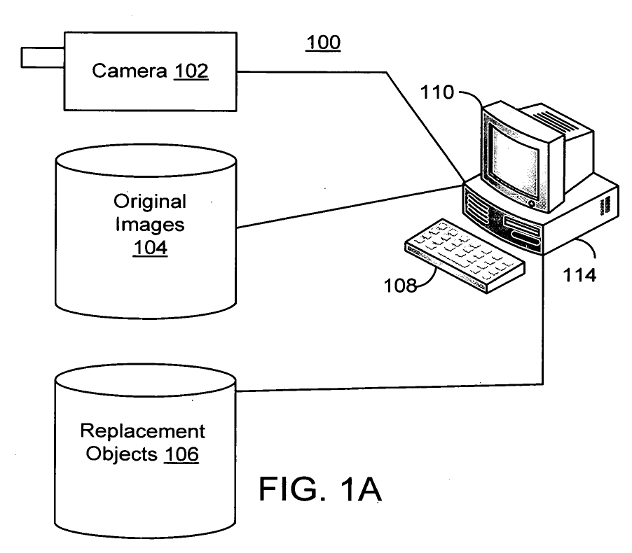

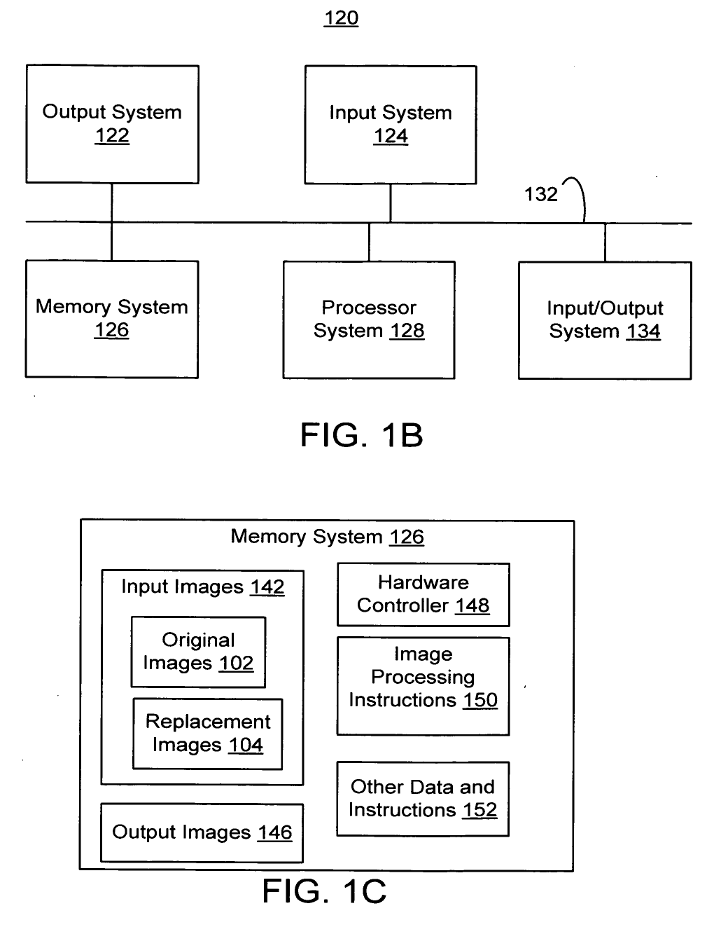

In general, at the beginning of the discussion of each of FIGS. 1A-C is a brief description of each element, which may have no more than the name of each of the elements in one of FIGS. 1A-C that is being discussed. After the brief description of each element, each element is further discussed in numerical order. In general, each of FIGS. 1A-9 is discussed in numerical order and the elements within FIGS. 1A-9 are also usually discussed in numerical order to facilitate easily locating the discussion of a particular element. Nonetheless, there is no one location where all of the information of any element of FIGS. 1A-9 is necessarily located. Unique information about any particular element or any other aspect of any of FIGS. 1A-9 may be found in, or implied by, any part of the specification. FIG. 1A shows an embodiment of a system 100 for manipulating images. System 100 may include camera 102, original images 104, replacement objects 106, output device 108, input device 110, and processing system 112. In other embodiments, system 100 may not have all of the elements listed and/or may have other elements instead of or in addition to those listed.

Camera 102 may be a video camera, a camera that takes still images, or a camera that takes both still and video images. Camera 102 may be used for photographing images containing a foreground of interest and/or photographing images having a background or other objects of interest. The images taken by camera 102 are either altered by system 100 or used by system 100 for altering other images. Camera 102 is optional.

Original images 104 is a storage area where unaltered original images having a foreground of interest are stored. Original images 104 may be used as an alternative input to camera 102 for capturing foreground images. In an embodiment, foreground images may be any set of one or more images that are extracted from one scene and inserted into another scene. Foreground images may include images that are the subject of the image or the part of the image that is primary focus of attention for the viewer. For example, in a video about people, the foreground images may include one or more people, or may include only those people that form the main characters of image. The foreground is what the image is about. Original images 104 are optional. Images taken by camera 102 may be used instead of original images 104.

Replacement objects 106 is a storage area where images of objects that are intended to be used to replace other objects in original images 104. For example, replacement images 106 may include images of backgrounds that are intended to be substituted for the backgrounds in original images 104. The background of an image is the part of the image that is not the foreground. Replacement images 106 may also include other objects, such as caricatures of faces or people that will be substituted for the actual faces or people in an image. In an embodiment, replacement images 106 may also include images that are added to a scene, that were not part of the original scene, the replacement object may be a foreground object or part of the background. For example, replacement images 106 may include images of fire hydrants, cars, military equipment, famous individuals, buildings, animals, fictitious creatures, fictitious equipment, and/or other objects that were not in the original image, which are added to the original image. For example, an image of a famous person may be added to an original image or to a background image along with a foreground to create the illusion that the famous person was standing next to a person of interest and/or in a location of interest.

Input device 108 may be used for controlling and/or entering instructions into system 100. Output device 110 may be used for viewing output images of system 100 and/or for viewing instructions stored in system 100.

Processing system 112 processes input images by combining the input images to form output images. The input images may be from camera 102, original images 104, and/or replacement images 106. Processor 112 may take images from at least two sources, such as any two of camera 102, original images 104, and/or replacement images 106.

In an embodiment, processing system 112 may separate portions of an image from one another to extract foreground and/or other elements. Separating portions of an image may include extracting objects and people of interest from a frame. The extracted objects and/or people may be referred to as the foreground. The foreground extraction can be done in one or more of three ways. One way that the foreground may be extracted is by identifying or learning the background, while the image does not have other objects present, such as during an initial period in which the background is displayed without the foreground. Another way that the foreground may be extracted is by identifying or learning the background even with other objects present and using object motion to identify the other objects in the image that are not part of the background. Another way that the foreground may be extracted is by intelligently extracting the objects from single frames without identifying or learning background.

Although FIG. 1A depicts camera 102, original images 104, replacement objects 106, output device 108, input device 110, and processing system 112 as physically separate pieces of equipment any combination of camera 102, original images 104, replacement objects 106, output device 108, input device 110, and processing system 112 may be integrated into one or more pieces of equipment. For example, original images 104 and replacement objects 106 may be different parts of the same storage device. In an embodiment, original images 104 and replacement objects 106 may be different storage locations within processing system 112. In an embodiment, any combination of camera 102, original images 104, replacement objects 106, output device 108, input device 110, and processing system 112 may be integrated into one piece of equipment that looks like an ordinary camera.

FIG. 1B shows a block diagram 120 of system 100 of FIG. 1A. System 100 may include output system 122, input system 124, memory system 126, processor system 128, communications system 132, and input/output device 134. In other embodiments, block diagram 120 may not have all of the elements listed and/or may have other elements instead of or in addition to those listed.

Architectures other than that of block diagram 120 may be substituted for the architecture of block diagram 100. Output system 122 may include any one of, some of, any combination of, or all of a monitor system, a handheld display system, a printer system, a speaker system, a connection or interface system to a sound system, an interface system to peripheral devices and/or a connection and/or interface system to a computer system, intranet, and/or internet, for example. In an embodiment, output system 122 may also include an output storage area for storing images, and/or a projector for projecting the output and/or input images.

Input system 124 may include any one of, some of, any combination of, or all of a keyboard system, a mouse system, a track ball system, a track pad system, buttons on a handheld system, a scanner system, a microphone system, a connection to a sound system, and/or a connection and/or interface system to a computer system, intranet, and/or internet (e.g., IrDA, USB), for example. Input system 124 may include camera 102 and/or a port for uploading images.

Memory system 126 may include, for example, any one of, some of, any combination of, or all of a long term storage system, such as a hard drive; a short term storage system, such as random access memory; a removable storage system, such as a floppy drive or a removable USB drive; and/or flash memory. Memory system 126 may include one or more machine readable mediums that may store a variety of different types of information. The term machine-readable medium is used to refer to any medium capable of carrying information that is readable by a machine. One example of a machine-readable medium is a computer-readable medium. Another example of a machine-readable medium is paper having holes that are detected that trigger different mechanical, electrical, and/or logic responses. Memory system 126 may include original images 104, replacement images 106, and/or instructions for processing images. All or part of memory 126 may be included in processing system 112. Memory system 126 is also discussed in conjunction with FIG. 1C, below.

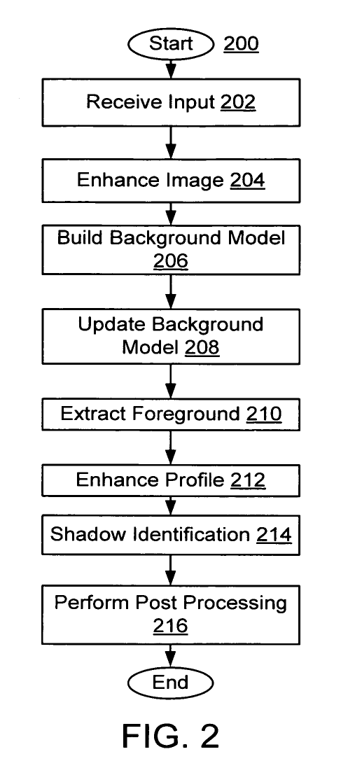

Processor system 128 may include any one of, some of, any combination of, or all of multiple parallel processors, a single processor, a system of processors having one or more central processors and/or one or more specialized processors dedicated to specific tasks. Optionally, processing system 128 may include graphics cards and/or processors that specialize in, or are dedicated to, manipulating images and/or carrying out of the methods FIGS. 2-7. Processor system 128 is the system of processors within processing system 112.

Communications system 132 communicatively links output system 122, input system 124, memory system 126, processor system 128, and/or input/output system 134 to each other. Communications system 132 may include any one of, some of, any combination of, or all of electrical cables, fiber optic cables, and/or means of sending signals through air or water (e.g. wireless communications), or the like. Some examples of means of sending signals through air and/or water include systems for transmitting electromagnetic waves such as infrared and/or radio waves and/or systems for sending sound waves.

Input/output system 134 may include devices that have the dual function as input and output devices. For example, input/output system 134 may include one or more touch sensitive screens, which display an image and therefore are an output device and accept input when the screens are pressed by a finger or stylus, for example. The touch sensitive screens may be sensitive to heat and/or pressure. One or more of the input/output devices may be sensitive to a voltage or current produced by a stylus, for example. Input/output system 134 is optional, and may be used in addition to or in place of output system 122 and/or input device 124.

FIG. 1C is a block diagram of an embodiment of memory system 126. Memory system 126 includes original images 104, replacement objects 106, input images 142, output images 146, hardware controller 148, image processing instructions 150, and other data and instructions 152. In other embodiments, memory system 126 may not have all of the elements listed and/or may have other elements instead of or in addition to those listed.

Original images 104 and replacement objects 106 were discussed above in conjunction with FIG. 1A. Input images 142 is a storage area that includes images that are input to system 100 for forming new images, such as original images 104 and replacement objects 106. Output images 146 is a storage area that include images that are formed by system 100 from input images 142, for example, and may be the final product of system 100. Hardware controller 148 stores instructions for controlling the hardware associated with system 100, such as camera 102 and output system 110. Hardware controller 148 may include device drivers for scanners, cameras, printers, a keyboard, projector, a keypad, mouse, and/or a display. Image processing instructions 150 include the instructions the implement the methods described in FIGS. 2-7. Other data and instructions 152 include other software and/or data that may be stored in memory system 126, such as an operating system or other applications.

### Switching Backgrounds

FIG. 2 is a flowchart of an embodiment of method 200 of manipulating images. Method 200 has at least three variations associated with three different cases. In an embodiment, videos (live or offline) may be the input (not only may still images be used for input for the foreground and/or background, but video images may be used for input). The input to this system can be in the form of images (in an embodiment, the images may have any of a variety of formats including but not limited to bmp, jpg, gif, png, tiff, etc.). In an embodiment, the video clips may be in one of various formats including but not limiting to avi, mpg, wmv, mov, etc. In an embodiment, video or still images (live or offline) may be the output. In an embodiment, only one video input is required (not two). The same input video may define scenes, without a person initially being present, from which a background model may be based. In an embodiment, an intelligent background model is created that adapts to changes in the background so that the background does not need to be just one fixed image. The background model is intelligent in that the background model automatically updates parameters associated with individual pixels and/or groups of pixels as the scene changes. The system may learn and adapt to changing background conditions, whether or not the changes are related to lighting changes or related to the introduction/removal of inanimate or other objects. The complexity of the image processing algorithms may be determined based on a scene's complexity and/or specific features. If the scene or input images have more edges, more clutter have more overlapping objects, changes in shadows, and/or lighting changes. In more complex scenes, the algorithm is more complex in that more convolution filters are applied, more edge processing is performed, and/or object segmentation methods may be applied to separate the boundary of various objects. The more complex algorithm may learn and/or store more information that is included in the background model. Since the image is more complex, more information and/or more calculations may be required to extract the foreground in later stages. In an embodiment, both the background and foreground images may be videos. In an embodiment, the background may be exchanged in real-time or off-line. In an embodiment, the boundary of a foreground element is blended with the background for realism. In an embodiment, the foreground elements may be multiple people and/or other objects as well.

Case I is a variation of method 200 for extracting the foreground (e.g., a person) in a situation in which there is an initial background available that does not show the foreground. The methods of case I can be applied to a video or to a combination of at least two still images in which at least one of the still images has a foreground and background and at least one other still image just has the background.

Initially, while starting or shortly after starting, a “video-based scene changing” operation may be performed, the system may learn the background and foreground (e.g., can identify the background and the person) by receiving images of the background with and without the foreground, which may be obtained in one of at least two ways. In one method, initially the foreground is not present in the scene, and the system may automatically detect that the foreground is not present, based on the amount and/or type of movements if the foreground is a type of object that tends to move, such as a person or animal. If the foreground is a type of object that does not move, the foreground may be detected by the lack of movement. For example, if the foreground is inanimate or if the background moves past the foreground in a video image (to convey the impression that the foreground is traveling) the background images may be detected by determining the value for the motion. Alternatively, the user presses a button to indicate that the foreground (which may be the user) is leaving the scene temporarily (e.g., for a few seconds or a few a minutes), giving an opportunity for the system to learn the scene. The system may analyze one or more video images of the scene without the foreground present, which allows the system to establish criteria for identifying pixels that belong to the background. Based on the scene without the foreground element of interest, a “background model” is constructed, which may be based on multiple images. From these images data may be extracted that is related to how each pixel tends to vary in time. The background model is constructed from the data about how each background pixel varies with time. For example, the background model may include storing one or more of the following pieces of information about each pixel and/or about how of the following information changes over time: minimum intensity, maximum intensity, mean intensity, the standard deviation of the intensity, absolute deviation from the mean intensity, the color range, information about edges within the background, texture information, wavelet information with neighborhood pixels, temporal motion, and/or other information.

Case II is a variation of method 200 for extracting a foreground in a situation in which no initial image is available without the foreground. For example, the foreground is already in the scene in the initial image and may be in the scene during all frames. The method of case II can be applied to a video or to a single still image or a set of still images having a background and foreground. In cases I and II the camera is mounted in a fixed manner, such as on a tripod so that the camera does not shake while the pictures are being taken. Case III is a variation of method 200 for extracting the foreground from the background in situations in which the camera is shaking or mobile while taking pictures. The method of case III can be applied to a video or to two still images of the same background and foreground, except the background and foreground have changed.

In step 202 data is input into system 100. In cases I and II in which the camera is fixed, the data that is input may be a live or recorded video stream from a stationary camera.

In case III in which the camera is not fixed, the data input may also be a live or recorded video stream from a non-stationary camera in which the camera may have one location but is shaking or may be a mobile camera in which the background scene changes continuously.

In step 204, the data is preprocessed. In an embodiment of cases I, II, and III, method 200 may handle a variety of qualities of video data, from a variety of sources. For example, a video stream coming from low-resolution CCD sensors is generally poor in quality and susceptible to noise. Preprocessing the data with the data pre-processing module makes the method robust to data quality degradations. Since most of the noise contribution to the data is in the high frequency region of the 2D Fourier spectrum, noise is suppressed by intelligently eliminating the high-frequency components. The processing is intelligent, because not all of the high frequency elements of the image are removed. In an embodiment, high frequency elements are removed that have characteristics that are indicative of the elements being due to noise. Similarly, high frequency elements that have characteristics that are indicative that the element is due to a feature of the image that is not an artifact are not removed. Intelligent processing may be beneficial, because true edges in the data also occupy the high-frequency region (just like noise). Hence, an edge map may be constructed, and an adaptive smoothing is performed, using a Gaussian kernel on pixels within a region at least partially bounded by an edge of the edge map. The values associated with pixels that are not part of the edges may be convolved with a Gaussian function. The edges may be obtained by the Canny edge detection approach or another edge detection method.

There are many different methods that may be used for edge detection in combination with the methods and systems described in this specification. An example of just one edge detection method that may be used is Canny edge detector. A Canny edge detector finds image gradients to highlight regions with high spatial derivatives. The algorithm then tracks along these regions and suppresses any pixel that is not at the maximum gradient (this process may be referred to as non-maximum suppression). The gradient array is now further reduced by hysteresis. Hysteresis is used to track the remaining pixels that have not been suppressed. Hysteresis uses two thresholds and if the magnitude is below the first threshold, the edge value associated with the pixel is set to zero (made a non-edge). If the magnitude is above the high threshold, it is made an edge. Also, if the magnitude lies between the two thresholds, then it is set to zero unless there is a path from this pixel to a pixel with a gradient above the second threshold.

In order to implement the Canny edge detector algorithm, a series of steps may be followed. The first step may be to filter out any noise in the original image before trying to locate and detect any edges, which may be performed by convolving a Gaussian function with the pixel values. After smoothing the image and eliminating the noise, the next step is to find the edge strength by taking the gradient of the image in the x and y directions. Then, the approximate absolute gradient magnitude (edge strength) at each point can be found. The x and y gradients may be calculated using Sobel operators, which are a pair of 3×3 convolution masks, one estimating the gradient in the x-direction (columns) and the other estimating the gradient in the y-direction (rows).

The magnitude, or strength of the gradient is then approximated using the formula:

|G|=|Gₓ|+|G_{y}|

The x and y gradients give the direction of the edge. In an embodiment, whenever the gradient in the x direction is equal to zero, the edge direction has to be equal to 90 degrees or 0 degrees, depending on what the value of the gradient in the y-direction is equal to. If G_{y} has a value of zero, the edge direction will equal 0 degrees. Otherwise the edge direction will equal 90 degrees. The formula for finding the edge direction is just:

θ=tan⁻¹(G_{y}/Gₓ)

Once the edge direction is known, the next step is to relate the edge direction to a direction that can be traced in an image.

After the edge directions are known, non-maximum suppression now has to be applied. Non-maximum suppression is used to trace the edge in the edge direction and suppress the pixel value of any pixel (by setting the pixel to 0) that is not considered to be an edge. This will give a thin line in the output image. Finally, hysteresis is applied to further improve the image of the edge.

In step 206, a background model is constructed. In the variation of method 200 of case I in which the background is photographed without the foreground, method 200 uses the image of the background without the foreground to build the background model. Visual cues of multiple features may be computed from the raw (e.g., unaltered) pixel data. The features that may be used for visual cues are luminance, chrominance, the gradient of pixel intensity, the edges, and the texture. The visual cues may include information about, or indications of, what constitutes an object, the boundary of the object and/or the profile of the object. Alternatively or additionally, the visual cues may include information to determine whether a pixel and/or whether the neighborhood and/or region of the scene belongs to the background of the scene or to the foreground object. The visual cues and the other information gathered may be used to decide whether to segment an object and decide if a pixel that probably belongs to a foreground based on the edge boundary or belongs to the background. A background model for each of the features of the background may be accumulated over a few initial frames of a video or from one or more still images of the background.

In case II, in which the background is not available without the foreground, an alternative approach is required. Motion pixels are detected in the frame to decide which region corresponds to the foreground. The motion may be estimated using near frame differencing and optical flow techniques. If the motion is not much or if the foreground is not moving or in a still image, and if the foreground is a person, then skin detection may be employed to locate the pixels that belong to a person. Skin detection is performed by analyzing the hue component of pixels in HSV color-space. Face detection may also be used for cases where the subject is in the view of camera offering a full-frontal view. In the case of a video, the process of detecting the region having the foreground (and hence the background region) is performed over several initial frames. Alternatively, if the foreground is not a person, knowledge about the expected visual characteristics of the foreground may be used to detect the foreground. For example, if the foreground is a black dog, pixels associated with a region having black pixels that are associated with a texture corresponding to the fur of the dog may be assumed to be the foreground pixels, and the other pixels may be assumed to be the background. Having obtained the region having the person, the background model is built for the remaining pixels, just as in case I. For other types of foreground elements other detection methods may be used. If the foreground leaves the scene after the initial scenes, and if the background image is being modified in real time, optionally some of the methods of case I may be applied, at that time to get a better background model. If the foreground leaves the scene after the initial scenes, and if the background image is not being modified in real time, optionally some of the methods of case I may be applied, to those frames to get a better background model that may be used in all frames (including the initial frames).

In case III, in which the camera shakes or moves or for video or for a collection of two or more still images from somewhat different perspectives, stabilization of the incoming frames or still images is performed. Stabilization may be done by computing the transformation relating the current frame and previous frame, using optical flow techniques. Accordingly, every new frame is repositioned, or aligned with the previous frame to make the new frame stable and the stabilized data is obtained as input for the subsequent processing modules.

In step 208, the background model is updated. Whether the camera is fixed or moving and whether the initial frames show a foreground (in other words, in cases I-III), in practical systems, the assumption of fixed background conditions cannot be made, hence necessitating the requirement for an intelligent mechanism to constantly update the background model. For a series of still images, the backgrounds are matched. The system may use several cues to identify which pixels belong to a foreground region and which do not belong to a foreground region. The system may construct a motion mask (if the foreground is moving) to filter foreground from the background. The system may detect motion by comparing a grid-based proximity of an image of the foreground to previously identified grid of the foreground (where a grid is a block of pixels). The grid based proximity tracks the location of the foreground with respect to the grid. A scene-change test, may be performed in order to determine whether a true scene change occurred or just a change of lighting conditions occurred. The analysis may involve analyzing the hue, saturation, and value components of the pixels. Additionally, a no-activity test may be performed to find which pixels should undergo a background model update. Pixels that are classified as having no activity or an activity that is less than a particular threshold may be classified as no activity cells, and the background model for the no activity pixels is not updated. Constructing a motion mask and performing the above test makes the system extremely robust to lighting changes, to the Automatic Gain Control (AGC), to the Automatic White Balance (AWB) of the camera, and to the introduction and/or removal of inanimate objects to and/or from the scene.

In step 210 the foreground extraction is performed. The foreground may be extracted after identifying the background via techniques such as finding differences in the current image from the background image. The foreground may be separated by near frame differencing, which may include the subtraction of two consecutive or relatively close frames from one another. Some other techniques for separating the foreground may include intensity computations, texture computations, gradient computations, edge computations, and/or wavelet transform computations. In intensity computations, the intensity of different pixels of the image are computed to detect regions that have intensities that are expected to correspond to the foreground. In texture computation, the texture of the different portions of the image is computed to determine textures that are expected to correspond to the foreground. In gradient computation, the gradient computation computes the gradients of the images to determine gradients on the pixel intensities that are indicative of the location of the foreground.

Often, the background is not fixed and hence needs to be learnt continuously. For example, in an embodiment, the system adapts to the lighting conditions. The foreground may be extracted from individual frames via techniques, such as auto and adaptive thresholding, color, and/or shape segmentation. In an embodiment, the extraction may be performed with or without manual interaction.

The foreground extraction may have two phases. In phase I, using the fixed camera of cases I and II, the background model classifies each pixel in the current frame as belonging to either background, foreground (e.g., a person), or “unknown.” The “unknown” pixels are later categorized as background or foreground, in phase II of the foreground extraction. Each pixel is assigned a threshold and is classified into either a background or foreground pixel depending on whether the pixel has a value that is above or below the threshold value of motion or a threshold value of another indicator of the whether the pixel is background or foreground. The determination of whether a pixel is a background pixel may be based on a differencing process, in which the pixel values of two frames are subtracted from one another and/or a range of colors or intensities. Regions having more motion are more likely to be associated with a person and regions having little motion are more likely to be associated with a background. Also, the determination of whether a pixel is part of the background or foreground may be based on any combination of one or more different features, such as luminance, chrominance, gradient, edge, and texture. If these different features are combined, the combination may be formed by taking a weighted sum in which an appropriate weighting factor for each are assigned to each feature. The weighting factors may be calculated based upon the scene's complexity. For example, for a “complex” scene (e.g., the subject and the background have similar colors), the gradient feature may be assigned significantly more weight than the threshold or intensity feature. There may be different thresholds for different portions of the foreground and/or background that are expected to have different characteristics. For a single still image, all of the pixels are classified as either background or foreground, and phase II is skipped.

In an embodiment, instead of having just two thresholds (one for the background and one for a foreground), for one or more features (e.g., the luminance, chrominance, etc.), there may be several thresholds for a pixel. For example, there may be two thresholds that bracket a range of intensities within which the pixel is considered to be a background pixel. There may be a set of one or more ranges within which the pixel may be considered to be a background pixel, a set of one or more ranges within which the pixel is considered to be a foreground pixel, and/or there may be a set of one or more ranges within which the determination of whether the pixel is a foreground or background pixel is delayed and/or made based on other considerations. Each pixel may have a different set of thresholds and/or different sets of ranges of intensities within which the pixel is deemed to be background, foreground, or in need of further processing. The variable thresholds and/or ranges may come from the model learnt for each pixel. These thresholds can also be continuously changed based on scene changes.

In case III in which the camera is mobile, a series of still images or frames of a video, a foreground tracking technique is employed to continuously keep track of the profile of the person, despite the constantly changing background. Foreground tracking may be done by a combination of techniques, such as color tracking and optical flow.

The foreground extraction of phase II is the same whether the camera is fixed or moving or whether the initial frames have a foreground or do not have a foreground. In each of cases I-III, the “unknown” pixels from the foreground extraction of phase I are classified into background or foreground using the temporal knowledge and/or historical knowledge. In other words, in phase I the pixel is classified based on information in the current scene. If the information in the current scene is inadequate for making a reasonably conclusive determination of the type of pixel, then historical data is used in addition to, and/or instead of, the data in the current scene. For example, if an “unknown” pixel falls into a region where there has been consistent presence of the foreground for the past few seconds, the pixel is classified as belonging to foreground. Otherwise, the pixel is classified as a background pixel.

Additionally, in case III, for the case of a mobile camera, the result of tracking from phase I is refined using a particle filter based contour tracking, which is a sequential Monte Carlo method for tracking the object boundaries. The particle filter based tracking also handles occlusions well.

The foreground may be extracted from individual frames via techniques, such as Auto and adaptive thresholding, color or shape segmentation, texture calculation, gradient calculation, edge computation, and/or wavelet transform computation. In an embodiment, the extraction may be performed with or without manual interaction.

In step 212, the profile is enhanced. For fixed and moving cameras whether or not the initial frames have a foreground, cases I and II, the output of the previous step is a map of pixels, which are classified as either being part of the foreground or the background. However, there is no guarantee that the pixels classified as foreground pixels form a shape that resembles the object that is supposed to be depicted by the foreground. For example, if the foreground objects are people, there is no guarantee that the collection of foreground pixels forms a shape that resembles a person or has a human shape. In fact, a problem that plagues most of the available systems is that the foreground pixels may not resemble the object that the foreground is supposed to resemble. To address this problem a profile enhancing module is included. A search may be conducted for features that do not belong in the type of foreground being modeled. For example, a search may be conducted for odd discontinuities, such as holes inside of a body of a person and high curvature changes along the foreground's bounding profile. The profile may be smoothened and gaps may be filled at high curvature corner points. Also, profile pixels lying in close vicinity of the edge pixels (e.g., pixels representing the Canny edge) in the image are snapped (i.e., force to overlap) to coincide with the true edge pixels. The smoothing, the filling in of the gaps, and the snapping operation creates a very accurate profile, because the edge pixels have a very accurate localization property and can therefore be located accurately. If the foreground includes other types of objects other than people, such as a box or a pointy star, the profile handler may include profiles for those shapes. Also, the types of discontinuities that are filtered out may be altered somewhat depending on the types of foreground elements that are expected to be part of the foreground.

In optional step 214, shadows are identified. Whether the camera is fixed or moving and whether the initial frames show a foreground (in other words, in cases I-III), an optional add-on to the person extraction may include a shadow suppression module. Shadow pixels are identified by analyzing the data in the Hue, Saturation, Value (HSV) color space (value is often referred to as brightness). A shadow pixel differs from the background primarily in its luminance component (which is the value of brightness) while still having the same value for the other two components. Shadows are indicative of the presence of a person, and may be used to facilitate identifying a person.

In step 216, post processing is performed. Whether the camera is fixed or moving and whether the initial frames show a foreground (in other words, in cases I-III), the post-processor module may allow for flexibility in manipulating the foreground and background pixels in any desired way. Some of the available features are blending, changing the brightness and/or contrast of the background and/or the foreground, altering the color of the background/foreground or placing the foreground on a different background. Placing of the foreground on a different background may include adding shadows to the background that are caused by the foreground.

To gain more realism, at the boundary of the person and the scene, called the “seam”, additional processing is done. The processing at the seam is similar to pixel merging or blending methods. First a seam thickness or blending thickness is determined or defined by the user. Alternatively, the seam thickness is determined automatically according to the likelihood that a pixel near an edge is part of the edge and/or background or according to the type of background and/or foreground element. In an embodiment, the seam can be from 1-3 pixels to 4-10 pixels wide. The width of seam may represent the number of layers of profiles, where each profile slowly blends and/or fades into the background. The pixels closer to the profile will carry more of the foreground pixel values (e.g., RGB or YUV). The percentage blending may be given by the formula:

New pixel=(% foreground pixel weight)*(foreground pixel)+(% background pixel weight)*background pixel

For a 1-layer blending the percentage of person pixel weight and background pixel weight may be 50-50%. For a two layer blending or smoothening, the percentage of person pixel weight and background pixel weight may be 67-33% for the first layer and may be 33-67% for the second layer. In an embodiment the percentage of background plus the percentage of foreground equals 100% and the percentage of background varies linearly as the pixel location gets closer to one side of the seam (e.g., nearer to the background) or the other side of the seam (e.g., nearer to the person). In another embodiment, the variation is nonlinear.

In an embodiment, each of the steps of method 200 is a distinct step. In another embodiment, although depicted as distinct steps in FIG. 2, step 202-216 may not be distinct steps. In other embodiments, method 200 may not have all of the above steps and/or may have other steps in addition to or instead of those listed above. The steps of method 200 may be performed in another order. Subsets of the steps listed above as part of method 200 may be used to form their own method.

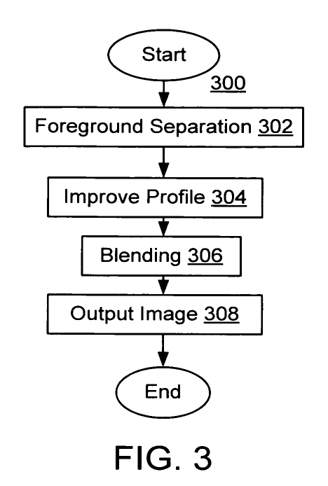

FIG. 3 shows a flowchart of another embodiment of a method 300 for manipulating images. Method 300 is an embodiment of method 200. In step 302 the background and foreground are separated. In step 304, the profile of the foreground is enhanced by applying smoothing techniques, for example.

As part of step 304, the background of the image or video is switched for another background. For example, new scene is created by inserting the person in the new background or video. If the new scene is a fixed image, then the person extracted is inserted first. Then the following blending or adjustment may be performed. The extracting of the person and the insertion of the new background is repeated at fast intervals to catch up and/or keep pace with a video speed, which may be 7-30 frames/sec.

The new scene is created by inserting the foreground in the new background scene or video. If the new scene is a fixed image, then the foreground extracted is inserted first. Then the following blending or adjustment is done as an option. The extracting of the person and the insertion of the new background is repeated at fast intervals to catch up and/or keep pace with a video speed of typically 7-30 frames/sec. In case a video is selected as a scene or background, then the following steps are performed. For each current image from the video, a current image of the video is extracted.

In step 306, the foreground is fused with another background or a variety of different elements are blended together, which may include manipulating the elements being combined. Then the two images are merged and operated upon. Then the results are posted to accomplish the Video-On-Video effect. For each current image from the video, a current image of the scene video is extracted. Then the two images are merged and operated upon. Blending and smoothening is also discussed in conjunction with step 216 of FIG. 2. In step 308, the results of the image manipulations are posted, which for example may accomplish a Video-On-Video effect. For example, the fused image is outputted, which may include display the fused image on a display, storing the fused image in an image file, and/or printing the image.

In an embodiment, each of the steps of method 300 is a distinct step. In another embodiment, although depicted as distinct steps in FIG. 3, step 302-308 may not be distinct steps. In other embodiments, method 300 may not have all of the above steps and/or may have other steps in addition to or instead of those listed above. The steps of method 300 may be performed in another order. Subsets of the steps listed above as part of method 300 may be used to form their own method.

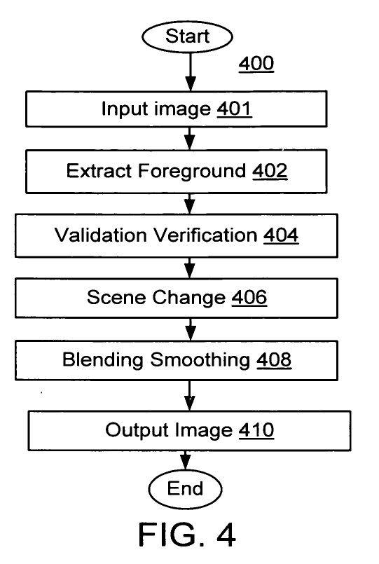

FIG. 4 shows a flowchart of another embodiment a method 400 for manipulating images. Method 400 is an embodiment of method 200. In step 401, an image is taken or is input to the system. In step 402, the foreground is extracted from the background, and the background and foreground are separated. In step 404, the foreground is verified. The verification may involve checking for certain types of defects that are inconsistent with the type of image being produced, and the verification process may also include enhancing the image. In an embodiment in which the foreground is one or more people, the people may be in any pose, such as standing, walking, running, lying, or partially hiding. The system may evaluate the profiles, blobs, and/or regions first. The system may perform a validation to extract only one foreground object or to extract multiple foreground objects. As part of the validation, the system may eliminate noise, very small objects (that are smaller than any objects that are expected to be in the image), and/or other invalid signals. Noise or small objects may be identified by the size of the object, the variation of the intensity of the pixels and/or by the history of the information tracking the foreground (e.g., by the history of the foreground tracking information). Then all the profiles or regions may be sorted by size, variation, and the probability that the profile is part of a foreground object. In embodiments in which the foreground objects are people, only the largest blobs with higher probability of being part of a person are accepted as part of a person.

In step 406, the background is switched for another background. In step 408, the foreground is fused with another background or a variety of different elements are blended together, which may include manipulating the elements being combined. In step 410, the fused image is outputted, which may include displaying the fused image on a display, storing the fused image in an image file, and/or printing the image.

In an embodiment, each of the steps of method 400 is a distinct step. In another embodiment, although depicted as distinct steps in FIG. 4, step 401-410 may not be distinct steps. In other embodiments, method 400 may not have all of the above steps and/or may have other steps in addition to or instead of those listed above. The steps of method 400 may be performed in another order. Subsets of the steps listed above as part of method 400 may be used to form their own method.

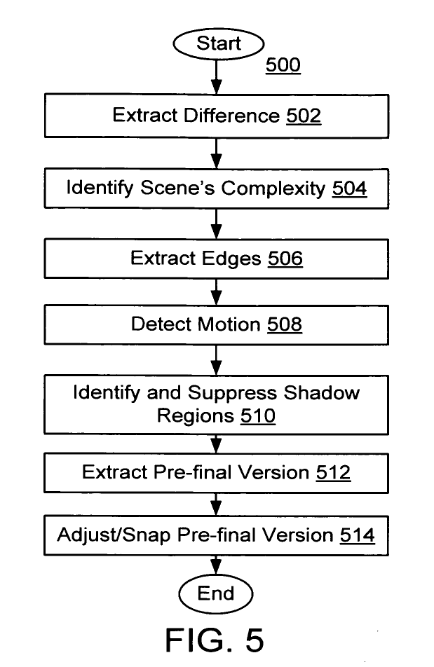

FIG. 5 shows an embodiment of a method 500 of extracting a foreground. When the foreground element (e.g., the user, another person, or another foreground element) enters the scene, the system may perform the extraction of the user in the following way. The system may use one or multiple details of information to determine the exact profile of the person. The algorithm may include the following steps. In step 502, the difference between the current video frame from the background model is subtracted. This may or may not be a simple subtraction. A pixel may be determined to be part of the background or foreground based on whether the pixel values fall into certain color ranges and/or the various color pixels change in intensity according to certain cycles or patterns. The background may be modeled by monitoring the range of values and the typical values for each pixel when no person is present at that pixel. Similarly, the ranges of values of other parameters are monitored when no person is present. The other parameters may include the luminance, the chrominance, the gradient, the texture, the edges, and the motion. Based on the monitoring, values are stored and/or are periodically updated that characterize the ranges and typical values that were monitored. The model may be updated over time to adapt to changes in the background.

In step 504, the current background's complexity is identified, and accordingly the appropriate image processing techniques are triggered, and the parameters and thresholds are adjusted based on the current background's complexity. The complexity of a scene may be measured and computed based on how many edges are currently present in the scene, how much clutter (e.g., how many objects and/or how many different colors) are in the scene, and/or how close the colors of the background and foreground objects are to one another. The complexity may also depend on the number of background and foreground objects that are close in color. In an embodiment, the user may have the option to specify whether the scene is complex or not. For example, if a person in the image is wearing a white shirt, and the background is also white, the user may want to set the complexity to a high level, whether or not the system automatically sets the scene's complexity.

In step 506, all edges and gradient information are extracted from the current image. Edges may be identified and/or defined according to any of the edge detection methods (such as Canny, Sobel etc and other technique can be used)). Appendix A discusses the Canny edge technique.

In optional step 508, motion clues are detected. The amount of motion may be estimated by subtracting the pixel values of two consecutive frames or two frames that are within a few frames of one another, which may be referred to as near frame differencing. Alternatively or additionally, motion may be measured by computing the optical flow. There are several variations or types of Optical Flow from which the motion may be estimated. As an example of just one optical flow technique, optical flow may be computed based on how the intensity changes with time. If the intensity of the image is denoted by I(xy,t), the change in intensity with time is given by the total derivative of the intensity with respect to time, which is

$$\frac{d I}{d t} = \frac{\partial I}{\partial x} \frac{d x}{d t} + \frac{\partial I}{\partial y} \frac{d y}{d t} + \frac{\partial I}{\partial t} .$$

If the image intensity of each visible scene point is unchanging over time, then

$$\frac{d I}{d t} = 0 ,$$

which implies

Iₓu+I_{y}v+Iₜ=0,

where the partial derivatives of I are denoted by the subscripts x, y, and t, which denote the partial derivative along a first direction (e.g., the horizontal direction), the partial derivative along a second direction (e.g., the vertical direction) that is perpendicular to the first direction, and the partial derivative with respect to time. The variables u and v are the x and y components of the optical flow vector.

For cases when it is not practical or not possible to use an empty scene as a starting point, only motion can be used to identify which portions of the scene might belong to a person, because the portions of the scene that have motion may have a higher probability of being a person. Additionally, the motion may indicate how to update the background model. For example, parts of the scene that do not have movement are more likely to be part of the background, and the model associated with each pixel may be updated over time.

In step 510, shadow regions are identified and suppressed. Step 510 may be performed by processing the scene in Hue, Saturation, Value (HSV or HSL) or LAB or CIELAB color spaces (instead of, or in addition to, processing the image in Red, Green, Blue color space and/or another color space). For shadow pixels, only the Value changes, while for non-shadow pixels, although the Value may change, the Hue and Saturation may also change. Other texture based methods may also be used for suppressing shadows. When the scene is empty from people and the background is being identified, shadow regions are not as likely to be present. Shadows tend to come into a picture when a person enters the scene. The location and shape of a shadow may (e.g., in conjunction with other information such as the motion) indicate the location of the foreground (e.g., person or of people).

In step 512 a pre-final version (which is an initial determination) of the regions representing the foreground are extracted. Next in step 514, the pre-final profile is adjusted/snapped to the closest and correct edges of the foreground to obtain the final profile. In a set of given foreground and/or background scenes, there may be multiple disconnected blobs or regions. Each profile may be a person or other element of the foreground. To snap the pre-final profile refers to the process of forcing the estimated foreground pixel near the edge pixel, to lie exactly on to the edge pixel. Snapping achieves a higher localization accuracy, which corrects small errors in the previous stages of identifying the image of the foreground. The localization accuracy is the accuracy of pixel intensities within a small region of pixels.

In an embodiment, each of the steps of method 500 is a distinct step. In another embodiment, although depicted as distinct steps in FIG. 5, step 502-514 may not be distinct steps. In other embodiments, method 500 may not have all of the above steps and/or may have other steps in addition to or instead of those listed above. The steps of method 500 may be performed in another order. Subsets of the steps listed above as part of method 500 may be used to form their own method.

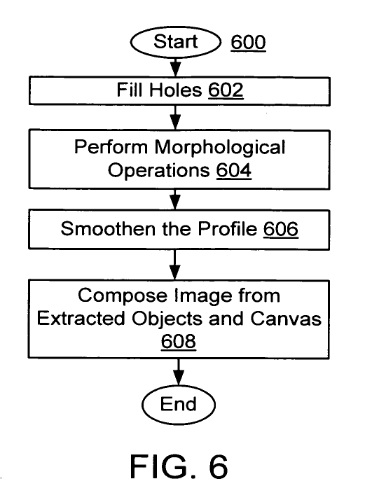

FIG. 6 shows a flow chart of an example of a method 600 for improving the profile of the foreground. In method 600, after the foreground has been initially extracted, the quality of extracted outer profile may be improved by performing the following steps. In step 602, holes in the foreground element may be automatically filled within all extracted foreground objects, or only those objects that are expected not to include any holes are filled in. In step 604, morphological operations, such as eroding and dilating are performed. Morphological operations may include transformations that involve the interaction between an image (or a region of interest) and a structuring element. More intuitively, dilation expands an image object with respect to other objects in the background and/or foreground of the image and erosion shrinks an image object with respect to other objects in the background and/or foreground of the image. In step 606, the profile of the foreground is smoothened, which, for example, may be performed by convolving pixel values with a Gaussian function or another process in which a pixel value is replaced with an average, such as a weighted average, of the current pixel value with neighboring pixel values. In step 608, once the foreground objects have been extracted from one or more sources, they are placed into a new canvas to produce an output image. The canvas frame can itself come from any of the sources that the foreground came from (e.g., still images, video clips, and/or live images).

In an embodiment, each of the steps of method 600 is a distinct step. In another embodiment, although depicted as distinct steps in FIG. 6, step 602-608 may not be distinct steps. In other embodiments, method 600 may not have all of the above steps and/or may have other steps in addition to or instead of those listed above. The steps of method 600 may be performed in another order. Subsets of the steps listed above as part of method 600 may be used to form their own method.

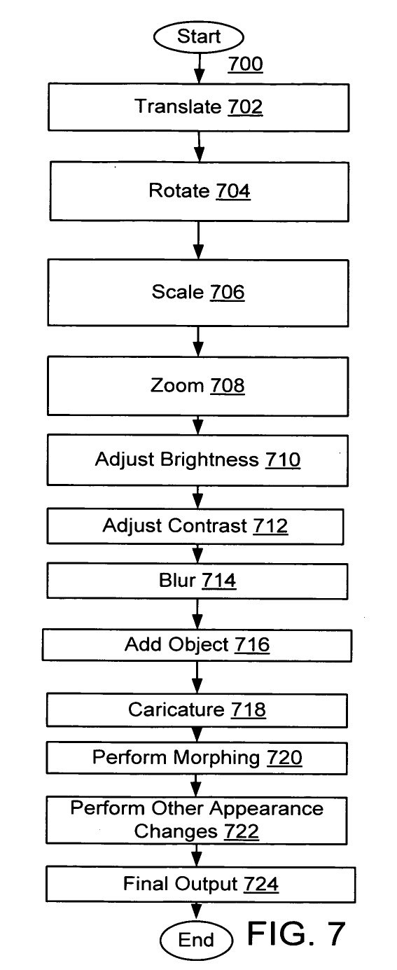

FIG. 7 shows a flowchart of an embodiment of a method 700 of fusing and blending elements. During method 700, the foreground may be individually transformed before they are placed on the canvas with one or more of the following transformations. In step 702, a translation of the foreground may be performed: The translation of step 702 may include a translation in any direction, any combination of translations of any two orthogonal directions and/or any combination of translations in any combination of directions. The amount of translation can be a fixed value or a function of time. The virtual effect of an object moving across the screen may be created by performing a translation.

In step 704, a rotation is performed. The rotation may be a fixed or specified amount of rotation, and/or the rotational amount may change with time. Rotations may create the virtual effect of a rotating object. In step 706 a scaling may be performed: During scaling, objects may be scaled up and down with a scaling factor. For example, an object of size a×b pixels may be enlarged to twice the object's original size of 2a×2b pixels on the canvas or the object may be shrunk to half the object's original size of

$$\frac{a}{2} \times \frac{b}{2}$$

pixels on the canvas. The scaling factor can change with time to create the virtual effect of an enlarging or shrinking object. In step 708, zooming is performed. Zooming is similar to scaling. However, during zooming only a portion of the image is displayed, and the portion displayed may be scaled to fit the full screen. For example, an object of 100×100 pixels is being scaled down to 50×50 pixels on the canvas. Now, it is possible to start zooming in on the object so that ultimately only 50×50 pixels of the object are placed on the canvas with no scaling.

In step 710, the brightness and/or illumination may be adjusted. Objects are made lighter or darker to suit the canvas illumination better. Brightness may be computed using a Hue, Saturation, Value color space, and the Value is a measure of the brightness. Brightness can be calculated from various elements and each object's brightness can be automatically or manually adjusted to blend that object into the rest of the scene.

In step 712, the contrast is adjusted. The contrast can be calculated for various elements and each object's contrast can be automatically or manually adjusted to blend the object's contrast into the entire scene. The difference between the maximum brightness value and the minimum brightness value is one measure of the contrast, which may be used while blending the contrast. The contrast may be improved by stretching the histogram of the region of interest. In other words, the histogram of all the pixel values is constructed. Optionally, isolated pixels that are brighter than any other pixel or dimmer than other pixel may be excluded from the histogram. Then the pixel values are scaled such that the dimmest edge of the histogram has the dimmest pixel possible value and the brightest edge of the histogram corresponds to the bright possible pixel value. The contrast can be calculated from various elements, and each of the object's contrast can be automatically or manually adjusted to even out for the entire scene.

In step 714, the elements of the image are blurred or sharpened. This is similar to adjusting focus and making objects crisper. Sharpness may be improved by applying an unsharp mask or by sharpening portions of the image. The objects can be blurred selectively by applying a smoothening process to give a preferential “sharpness” illusion to the foreground (e.g., the user, another person, or another object).

In step 716, one or more objects may be added on, behind, or besides the foreground. Once the location, position, and/or orientation of an object is obtained, the object may be added to the scene. For example, if the foreground is a person, images of clothes, eye glasses, hats, jewelry, makeup, different hair styles etc. may be added to the image of a person. Alternatively a flower pot or car or house can be placed beside or behind the person. After obtaining the position, orientation, scale, zoom level, and/or a predefined object size, shape, and/or limits, the foreground and the virtual object added may be matched, adjusted, superimposed, and/or blended.

In step 718, caricatures of objects may be located within the scene in place of the actual object. Faces of people can be replaced by equivalent caricature faces or avatars. A portion of one person's face may be distorted to form a new face (e.g., the person's nose may be elongated, eyes may be enlarged and/or the aspect ratio of the ear may be changed). Avatars are representations of people by an icon, image, or template and not the real person, which may be used for replacing people or other objects in a scene and/or adding objects to a scene.

In step 720, morphing is performed. Different portions of different foregrounds may be combined. If the foreground includes people's faces, different faces may be combined to form a new face. In step 722, appearances are changed. Several appearance-change transformations can be performed, such as, a face change (in which faces of people are replaced by other faces), a costume change (in which the costume of people are be replaced with a different costume).

Some of these objects or elements may come from stored files. For example, a house or car or a friend's object can be stored in a file. The file may be read and the object may be blended from the pre-stored image and NOT from the live stream. Hence elements may come from both Live and Non-Live stored media. Once the foreground objects have been placed on the canvas, certain operations are performed to improve the look and feel of the overall scene. These may include transformations, such as blending and smoothening at the seams.

In step 724, the final output may be produced. The final output of the system may be displayed on a monitor or projected on a screen, saved on the hard disk, streamed out to another computer, sent to another output device, seen by another person over IP phone, and/or streamed over the Internet or Intranet.

In an embodiment, each of the steps of method 700 is a distinct step. In another embodiment, although depicted as distinct steps in FIG. 7, step 702-724 may not be distinct steps. In other embodiments, method 700 may not have all of the above steps and/or may have other steps in addition to or instead of those listed above. The steps of method 700 may be performed in another order. Subsets of the steps listed above as part of method 700 may be used to form their own method.

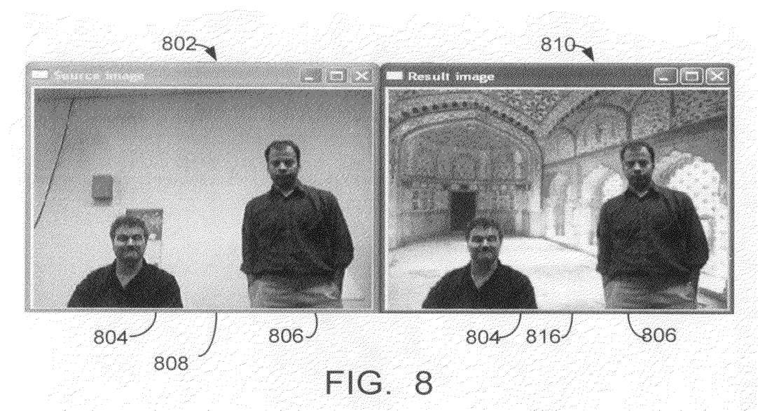

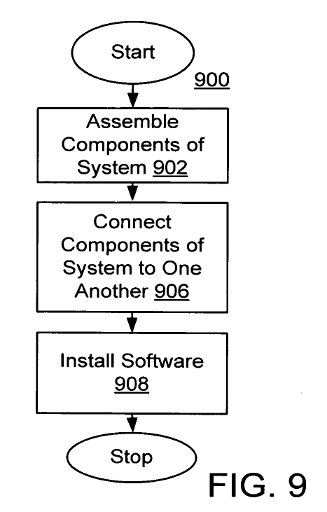

FIG. 8 shows example 800 of switching the background image. Example 800 includes source image 802, first foreground image 804, second foreground image 806, original background 808, result image 810, and replacement background 816.

Source image 802 is an original unaltered image. First foreground image 804 and second foreground image 806 are the foreground of source image 802, and in this example are a first and second person. Background 808 is the original unaltered background of source image 802. Result image 810 is the result of placing first foreground image 804 and second foreground image 806 of source image 802 on a different background. Background 816 is the new background that replaces background 808. In other embodiments, example 800 may not have all of the elements listed and/or may have other elements instead of or in addition to those listed.

FIG. 9 is a flowchart of an example of a method 900 of making system 100. In step 902 the components of system 100 are assembled, which may include assembling camera 102, original images 104, replacement objects 106, output device 108, input device 110, processing system 112, output system 122, input system 124, memory system 126, processor system 128, communications system 132, and/or input/output device 134. In step 906 the components of the system are communicatively connected to one another. Step 906 may include connecting camera 102, original images 104, replacement objects 106, output device 108, input device 110 to processing system 112. Additionally or alternatively, step 906 may include communicatively connecting output system 122, input system 124, memory system 126, processor system 128, and/or input/output device 134 to communications system 132, such that output system 122, input system 124, memory system 126, processor system 128, input/output device 134, and/or communications system 132 can communicate with one another. In step 908, the software for running system 100 is installed, which may include installing hardware controller 148, image processing instructions 150, and other data and instructions 152 (which includes instructions for carrying out the methods of FIGS. 2-7). Step 908 may also include setting aside for memory in memory system 126 for original images 104, replacement objects 106, input images 142, and/or output images 146.

In an embodiment, each of the steps of method 900 is a distinct step. In another embodiment, although depicted as distinct steps in FIG. 9, step 902-908 may not be distinct steps. In other embodiments, method 900 may not have all of the above steps and/or may have other steps in addition to or instead of those listed above. The steps of method 900 may be performed in another order. Subsets of the steps listed above as part of method 900 may be used to form their own method.

Each embodiment disclosed herein may be used or otherwise combined with any of the other embodiments disclosed. Any element of any embodiment may be used in any embodiment.

Although the invention has been described with reference to specific embodiments, it will be understood by those skilled in the art that various changes may be made and equivalents may be substituted for elements thereof without departing from the true spirit and scope of the invention. In addition, modifications may be made without departing from the essential teachings of the invention.

1. A method comprising:
receiving an image having a first portion and one or more other portions; and
replacing the one or more other portions with one or more other image, the replacing results in an image consisting of the first portion and the one or more other image.

2. The method of claim 1 further comprising:
receiving at least one image that has the one or more other images, but that does not have the first image; and
forming a model of the one or more other images based on the at least one image that has the one or more other images, but that does not have the first image.

3. The method of claim 1, further comprising:
remove image elements that are expected to be noise as a result of a frequency of variation associated with that element;
construct an edge map indicative of edges of image objects;
apply a smoothing technique within regions bounded by the edges identified by the edge map; and
construct a background model.

4. The method of claim 3, further comprising: constructing the background model includes collecting information about the background based on images showing the background without the foreground.

5. The method of claim 4, the collecting of the information about the background including collecting information about a luminance, a chrominance, a hue, a texture, and a gradient associated with one or more pixels of the background.

6. The method of claim 1 including computing a transformation for the image that compensates for a shaking of a camera capturing the image.

7. A system comprising a machine readable medium storing instruction that cause the system to implement the method of claim 1.

8. A method comprising:
extracting one or more image elements from a first image;
retrieving one or more image elements from another source;
combining the one or more image elements from the first image and the one or more image elements from the other source to form a new image.

9. The method of claim 8, the other source being a storage media that stores predefined image elements.

10. The method of claim 8, wherein the other source being another image, the retrieving including at least extracting the one or more other image elements from the other image.

11. The method of claim 8, further comprising transforming one or more other image elements in conjunction with the combining.

12. The method of claim 8, the first image being a set of images forming a video.

13. The method of claim 8, the other source being a set of images forming a video.

14. The method of claim 8, results of the combining being a set of images forming a video.

15. A system comprising a machine readable medium storing instruction that cause the system to implement the method of claim 8.

16. A method comprising:
determining whether a pixel is part of a foreground portion of an image, the determining of whether the pixel is part of the foreground being based on a current frame;
determining whether the pixel is part of a current background portion of the image, the determining of whether the pixel is part of the current background being based on the current frame; and
extracting an image of the foreground that does not include the current background based on the determining of whether the pixel is part of the foreground and based on the determining of whether the pixel is part of the background.

17. The method of claim 16 further comprising:
the determining of whether the pixel is the foreground portion does not determine the pixel to be part of the foreground portion, and
the determining of whether the pixel is part of the current background portion does not determine the pixel to be part of the background portion,
then, determining whether the pixel is part of the background portion or foreground portion based on temporal data.

18. A system comprising a machine readable medium storing instruction that cause the system to implement the method of claim 16.

19. The method of claim 16 further comprising:
determining a motion associated with regions of the image; and
determining which pixels are background pixels based on whether the motion is within a range of values of motion that is expected to be associated with the background.

20. The method of claim 16, the foreground being one or more images of one or more people and determining the foreground pixel includes at least determining whether the pixels having a coloring that are expected to be associated with the one or more people.

21. The method of claim 20, the coloring including a hue associated with skin.

22. The method of claim 16, determining regions to be part of the background, based on the regions having a motion that is less than a particular amount, and updating the background based on the determining of the regions.

23. The method of claim 22, the updating of the background including changing pixel values of background pixels to indicate changes in lighting associated with the background.

24. The method of claim 16,
the extracting of the image of the foreground including a first phase and a second phase,
the first phase including at least
classifying pixels having a first range of motion values as background pixels
classifying pixels having a second of range of motion values as foreground pixels, the first range does not overlap the second range,
undetermined pixels, which are pixels having a motion value that is not in the first range and not in the second range, are not classified as background or foreground as part of the first phase; and
during the second phase, classifying the undetermined pixels as background or foreground based one or more other criteria.

25. The method of claim 16, further comprising:
determining a complexity for one or more regions of a scene, and
adjusting one more criteria for determining whether a pixel is a background or foreground pixel, based on the complexity.
